(19) United States
(12) Patent Application Publication
(10) Pub. No.: US 2009/0132991 A1
(43) Pub. Date: May 21, 2009

(54) PARTIAL ORDER REDUCTION FOR SCALABLE TESTING IN SYSTEM LEVEL DESIGN

(75) Inventors: Malay K. Ganai, Plainsboro, NJ (US); Sudipta Kundu, San Diego, CA (US)

Correspondence Address: NEC LABORATORIES AMERICA, INC., 4 INDEPENDENCE WAY, Suite 200, PRINCETON, NJ, 08540, US

(73) Assignee: NEC Laboratories America, Inc, Princeton, NJ (US)

(21) Appl. No.: 12/265,347

(22) Filed: Nov. 5, 2008

Related U.S. Application Data
(60) Provisional application No. 60/988,639, filed on Nov. 16, 2007.

(51) Int. Cl. G06F 17/50

(52) U.S. Cl. 716/18

(57) ABSTRACT

A system and method for program testing includes, using a static analysis, determining dependency relations of enabled running processes in a program. The dependency relations are organized in a matrix to provide an interface for exploring the program. A reduced set of possible executions obtained by removal of redundant interleavings as determined with respect to the dependency relation, is explored on the program in a stateless exploration process that analyzes executed states and transitions to verify operation of the program.

### RELATED APPLICATION INFORMATION

This application claims priority to provisional application Ser. No. 60/988,639 filed on Nov. 16, 2007, incorporated herein by reference.

### BACKGROUND

1. Technical Field

The present invention relates to system level design (SLD) and more particularly to systems and method for performing partial order reduction that accounts for all behaviors of a SystemC program or other SLD program.

2. Description of the Related Art

SystemC has become a defacto standard (e.g., Open SystemC Initiative (OSCI)) for the modeling of SoC (system on a chip) designs at various levels of abstraction from cycle accurate to untimed functional models. SystemC is essentially a C++ library that provides macros to model hardware and software systems. SystemC is being increasingly used for writing Transaction level models (TLM) that allow development of embedded software with the use of features such as synchrony, asynchrony, reactive and timed specifications. Such a system-modeling language is used to generate a reference model (i.e., build a prototype) for the SoC design flow, but not necessarily implement the model. SystemC semantics permits both synchronous and asynchronous features, with a notion of time. Specifically, SystemC permits features such as co-operative multitasking, delayed/immediate notification, wait-to-wait atomicity, blocking and non-blocking variables updates.

Unfortunately, SystemC does not have formal semantics, and such models were intended to speed up simulation. Simulation, on the other hand, does not guarantee completeness in verification or validation as it cannot expose all possible ordering of events.

Recently, formal verification techniques have been proposed to overcome the limitation described above. Due to lack of formal semantics, previous works are focused on translating SystemC and TLM specific features into some formal languages for which there exist some verification back-ends. SystemC is translated into a purely synchronous formalism or it is translated into a purely asynchronous formalism. Since SystemC is not entirely synchronous or asynchronous, special encoding/translation are required to convert the asynchronous part for synchronous formalism, and the synchronous part for asynchronous formalism. In general, such translations often have been found to add additional complexities for the back-end engines, and are not very scalable solutions.

Referring to FIG. 1, three conventional approaches are illustratively depicted in a chart. In approach 11, SystemC TLM models are translated into Heterogeneous Parallel Input Output Machines (HPIOM), which are synchronous models. These models are represented using formal languages such as LUSTRE or SMV, which are verified using respective backend formal engines. In approach 12, the SystemC TLM models are translated into asynchronous models and represented using PROMELA. This is then verified using a SPIN model checker. In approach 13, an SMV (synchronous) model may also be built fully interleaved (Rule based) or with a step scheduler (NuSMV) that manages the execution of events. Note, none of these approaches, exploits the inherent formalism existing in SystemC.

Dynamic validation of SystemC is carried out by exploring a sufficient subset of all interleaving for a given data input. The redundant interleaving is eliminated by exploiting the dependency information collected and analyzed from the execution trace, which can affect the run-time of the dynamic validation.

Growing complexity of systems and their implementation into silicon encourages designers to look for ways to model designs at higher levels of abstraction and then incrementally build portions of these designs—automatically or manually—while ensuring system-level functional correctness. SystemC is aptly described as a system description language, which allows modeling a design in different levels of abstraction (both low and high level). However, SystemC exhibits its real power during Transaction Level Modeling (TLM) and behavior modeling. For instance, researchers have advocated the use of SystemC models and their step-wise refinement into interacting hardware and software components. The increasing popularity of SystemC in the SoC industry has helped it to become the de-facto standard for modeling of SoC in various different levels of abstraction. SystemC is a set of library routines and macros implemented in C++, which makes it possible to simulate concurrent processes, each described by ordinary C++ syntax. Instantiated in the SystemC framework, the objects described in this manner may communicate in a simulated real-time environment, using shared variables of datatypes offered by C++, some additional ones offered by the SystemC library, as well as user defined. SystemC is both a description language and a simulation kernel. The code written will compile together with the library's simulation kernel to give an executable that behaves like the described model when it is run.

SystemC semantics allows both synchronous and asynchronous features, with a notion of time. Specifically, it allows features such as co-operative multitasking, delayed/immediate notification, wait-to-wait atomicity, blocking and non-blocking variables updates. Unfortunately, SystemC does not have formal semantics, and such models were intended to speed up simulation. Simulation, on the other hand, does not guarantee completeness in verification or validation as it cannot expose all possible ordering of events. Testing a SystemC design corresponds to simulating it by using a simulation kernel, which include a deterministic implementation of the scheduler, whose specification is non-deterministic. Thus, simulation of SystemC design cannot guarantee correctness due to its inability to produce all possible behaviors.

### SUMMARY

A system and method for program testing includes, using a static analysis, determining dependency relations of enabled running processes in a program. The dependency relations are organized in a matrix to provide an interface for exploring the program. A reduced set of possible executions on the program is explored in a stateless exploration process that analyzes executed states and transitions to verify operation of the program.

A method for concurrent program testing includes determining dependency relations of running processes in a concurrent program and organizing them in a matrix, obtaining a reduced set of possible interleavings of processes by removing equivalent interleavings as determined with respect to the dependency relations, and exploring the reduced set of interleavings to verify operation of the program.

A system for program testing includes a static analyzer configured to determine dependency relations of enabled running processes in a program, and a query table configured to organize the dependency relations to provide an interface for exploring the program. An explorer engine is configured to explore a reduced set of possible interleavings in the program in a stateless exploration process that analyzes executed states and transitions to verify operation of the program.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram showing three conventional approaches for system level design verification;

FIG. 2 is a block/flow diagram showing a system/method for program verification of system level designs using partial order reduction for scalable testing;

FIG. 3 is a block/flow diagram showing a system/method for determining dependent relations in a program;

FIG. 4 is an example producer-consumer program provided to demonstrate the present principles;

FIG. 5 is an example explore program for exploring a program in accordance with the present principles;

FIG. 6 is a diagram of a partial execution tree showing a first delta-cycle; and

FIG. 7 is a block/flow diagram showing a system/method for a prototype system in accordance with the present principles.

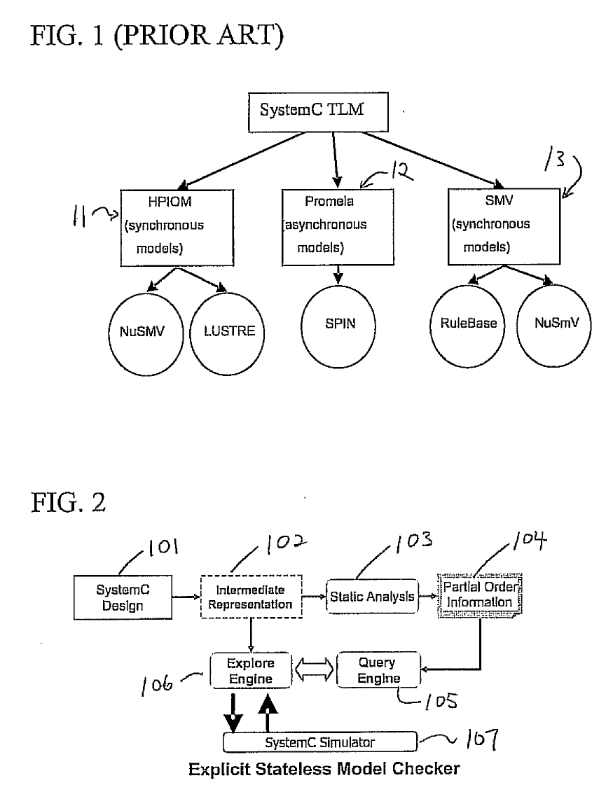

### DETAILED DESCRIPTION OF PREFERRED EMBODIMENTS

In accordance with the present principles, illustrative embodiments herein focus on using formal verification techniques developed for software to extend dynamic validation of SystemC transaction level models (TLM). To cope with the state-space-explosion problem associated with any concurrent system, we employ a combination of static and dynamic partial order reduction (POR) techniques. However, unlike pure dynamic techniques, we use the information obtained by static analysis in a query-based framework, rather than dynamically collecting the information and analyzing it during runtime. Using static information, we tradeoff precision for performance since for most SystemC designs, we can find the dependency relation quite precisely by using static analysis only. The present approach infers the persistent sets dynamically using information obtained by static analysis. To further reduce the number of explored traces, we use sleep sets in conjunction with the above technique. The present embodiments intend to reduce the set of interleaving needed to explore, thereby, reducing search state space. The present embodiments also reduce the verification time of concurrent programs by pre-computing the information statically. An interleaving is a total ordered sequence of transitions (i.e., actions) of threads that are interleaved (or interlaced). It is also referred to as “interleaved schedule” or simply a “schedule”.

A practical automatic technique is presented for checking all possible execution traces of a SystemC design or other design. We can assume representative inputs are already provided, and focus mainly on detecting deadlocks, write-conflicts and safety property violations such as assertion violations. Note that termination can be guaranteed in SystemC by bounding the execution length during simulation. Static analysis can be employed to compute if two atomic blocks are independent, meaning that their execution does not interfere with each other, and changing their order of execution will not alter the combined effect. Next, we start by executing one random trace of the program until completion, and then dynamically compute backtracking points along the trace that identify alternative transitions that need to be explored because they may lead to different final states. Unlike pure dynamic techniques, we use the information obtained by static analysis, rather than dynamically collecting the information and analyzing it during runtime. We also improve the performance of the dynamic partial order reduction (POR) by not analyzing the transitions if we already know for sure from the static information that the two transitions do not interact (i.e. they are independent).

A query-based framework combines static and dynamic POR techniques to cover all possible executions in a SystemC design. We reduce the runtime overhead by computing the information statically, and use it during runtime, without much loss of precision. SystemC specific semantics are employed to further improve the efficiency of the POR techniques. In SystemC, processes are co-operatively multitasking and support the concept of delta ( [symbol] )-cycle. The synchronous semantics of SystemC reduce the size of persistent set and hence, analysis of backtracking points, immensely.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

Referring now to the drawings in which like numerals represent the same or similar elements and initially to FIG. 2, a system/method for modeling and verification of SystemC (TLM) models is illustratively shown. In block 101, given a SystemC design, an intermediate representation (IR) 102 is obtained. An intermediate representation may include hierarchical task graphs (HTGs) or other representations. In block 103, a static analysis is performed.

Partial order reduction (POR) techniques are extensively used by software model checkers for reducing the size of the state space of concurrent software system at the implementation level. Other state space reduction techniques for reducing the time and/or space complexity, such as slicing, abstraction, are orthogonal, and, as such, can be used in conjunction with POR. The POR techniques can be divided in two main categories: static and dynamic. The main static POR techniques are persistent/stubborn sets and sleep sets. The persistent/stubborn set techniques compute a provably sufficient subset of the enabled transitions in each visited states such that if we do a selective search only by using transitions from these sub-sets we are guaranteed to detect all the deadlocks and safety property violations. All these algorithms infer the persistent sets from the static structure (code) of the system being verified. On the other hand, the sleep set techniques uses information about the past of the search and dependencies between the enabled transitions of each visited state. Both these techniques are orthogonal and can be applied simultaneously.

In contrast, the dynamic POR technique starts by executing the program until completion, and then infers the persistent sets dynamically by collecting information about how threads have communicated during this specific execution trace.

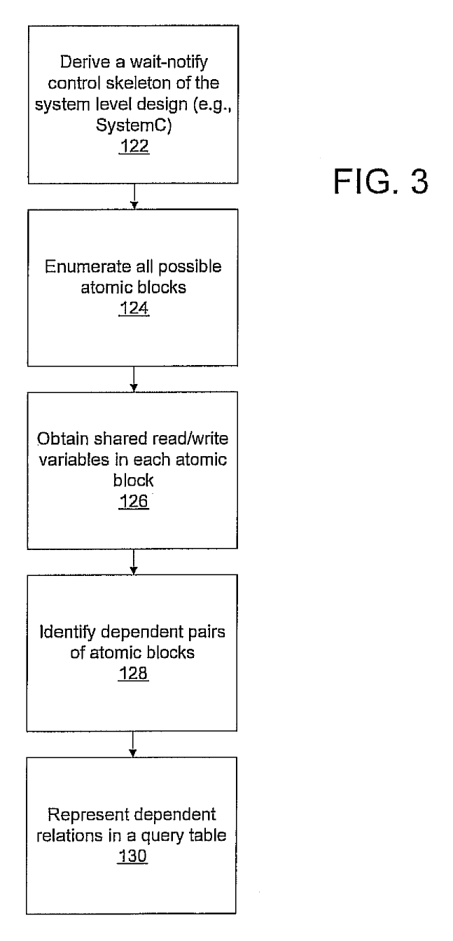

We obtain dependency relations (partial order information) in block 104 of runnable processes (e.g. a set of processes that are enabled) from SystemC designs directly using the static analysis in block 103, as opposed to obtaining information from post-translated models. Block 104 includes the following sub-steps as depicted in FIG. 3.

Referring to FIG. 3, in block 122, a wait-notify control skeleton of the system level design (e.g. SystemC design) is derived. This is a wait-notify graph depicting the wait-notify actions of the program during execution. In block 124, we then enumerate all possible atomic blocks, where an atomic block in SystemC is a non-preemptive sequence of transitions between wait to wait. In block 126, we obtain shared read and write variables set in each atomic block. In block 128, we identify a set of pair-wise atomic blocks that are dependent. An atomic execution is dependent on another atomic execution if it is enabled or disabled by the other or there exists read-write or write-write or wait-notify conflicts on the shared variable accesses in these blocks. In block 130, we represent the dependency relation between the atomic blocks in a query table. During the model checking phase, we query to check if a given pair of atomic blocks (corresponding to the runnable processes) need to be interleaved. If not, we do not consider that interleaving of runnable processes in the model checking.

Referring again to FIG. 2, in block 105, we capture the dependency relation in a Query table and provide an interface to an Explore engine using a query engine. In block 106, the Explore engine explores a reduced set of possible executions of a SLD (e.g., SystemC) design in a simulator 107 (e.g., a SystemC simulator), which simulates the execution of the SystemC program/design. The present system/method is stateless, i.e., it stores no state representations in memory but only information about which transitions and traces have been executed so far.

Although, the present approach may be slower than a method that maintains full state information, the present system/method uses considerably less amount of memory, especially when the design has a large number of variables. The present system/method explores each nonequivalent trace of the system by re-executing the design from its initial state. The SystemC design is compiled with a verification module which includes a modified OSCI's SystemC kernel. The modified kernel implements the Simulate function of Explore (SystemC simulator 107). It takes as input a prefix schedule and executes it until completion such that the prefix of the executed trace is same as the trace corresponding to the input prefix schedule. The modifications are still in compliance with the SystemC specification.

In blocks 103 and 104, dependency information of the runnable processes (i.e. set of processes that are enabled) are pre-computed from SystemC designs directly and statically, as opposed to obtaining them from post-translated models. In block 105, the dependency information is captured succinctly as 2-dimensional matrix with single bit information (per cell) storing whether a pair is dependent or not. In block 106, in the explore method, we use the pre-computed dependency information to avoid exploring the interleaving of the transitions that are not dependent. We combine the pre-computed dependency information with a SystemC simulation kernel (107).

The contributions in accordance with the [resent principles, include at least: 1) a novel query-based framework that combines static and dynamic POR techniques to cover all possible executions of a SystemC design. We reduce the runtime overhead by computing the dependency information statically, and use the dependency information during runtime, without much loss of precision. 2) We use SystemC specific semantics to further improve the efficiency of the POR techniques. In SystemC, processes are co-operatively multitasking and support the concept of a δ-cycle. The synchronous semantics of SystemC reduces the size of the persistent set and consequently immensely reduces the analysis of backtracking points.

The Open SystemC Initiative's (OSCI) SystemC simulator 107 is employed to implement the present principles by exploring all possible behaviors of a SystemC design in a validating procedure of a SystemC program.

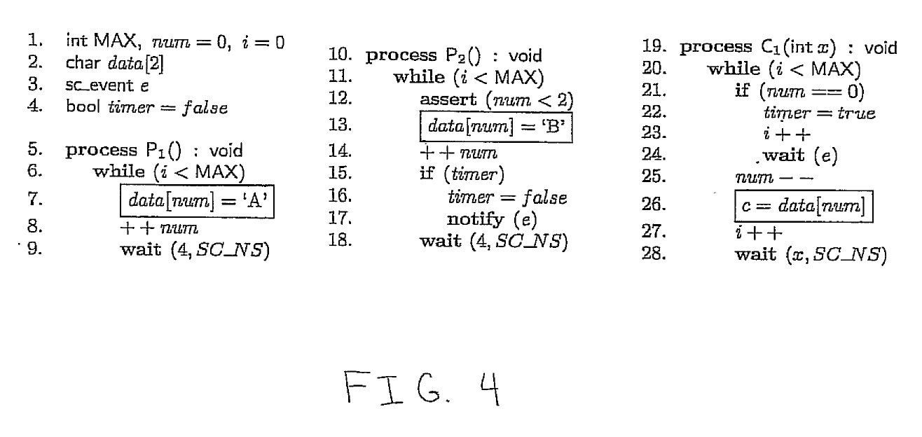

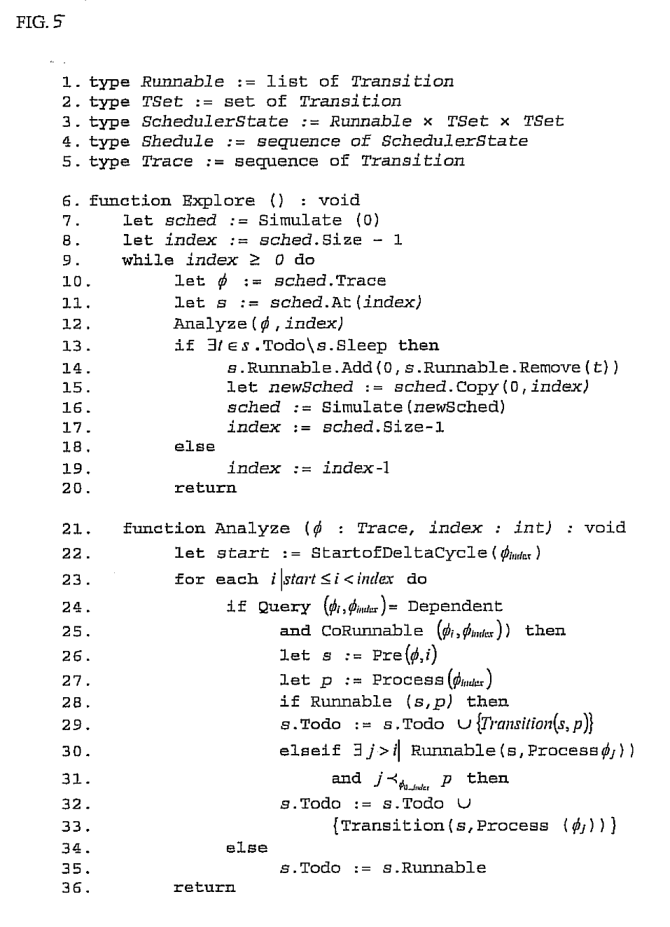

Referring to FIG. 4, a simple producer-consumer example program is illustratively shown. This example highlights the kind of synchronization normally expected in an SLD language. As mentioned, SystemC is essentially a C++ library that provides macros and APIs to model hardware and software systems. A SystemC program is a set of interconnected modules communicating through channels, signals, events and shared variables collectively called communication objects. A module is composed of a set of ports, variables, processes and methods. Processes are small pieces of code that run concurrently with other processes and are managed by a non-preemptive scheduler. The semantics of concurrency is cooperatively multitasking, a type of multitasking in which the process currently executing must offer control to other processes. As such, a wait-to-wait block in a process is atomic. The processes exchange data between themselves by using shared variables (signals and non-signals). During the execution of a SystemC design, all signal values are stable until all processes reach the waiting state. When all processes are waiting, signals are updated with the new values. In contrast, the non-signal variables are standard C++ variables which are updated immediately during execution.

For simplicity, syntactic details of SystemC are not shown in FIG. 4. The program of FIG. 4 has three processes namely N (lines 5-9), P₂ (lines 10-18) and C₁ (lines 19-28). The global variables of the program are shown in lines 1-4. The program uses a shared data array as buffer, and an integer num, which indicates the total number of elements in the buffer. The producer P₁ in a loop writes to the buffer and then synchronizes by waiting (or blocking) (line 9) on time. Similarly, producer P₂ writes to the buffer and if timer is set then notifies the event e and then synchronizes using time. The consumer C₁ on the other hand, waits (or blocks) (line 24) on the event e when the buffer is empty, until the notify (line 17) on e is invoked in the P₂ process.

If there are elements in the buffer then C₁ consumes the elements and synchronizes on time like the other processes. For synchronization SystemC uses wait-notify on events and time. We will use this example to guide the following discussion.

ELABORATION AND SIMULATION: The execution of a SystemC application includes elaboration followed by simulation. The primary purpose of elaboration is to create internal data structures within the kernel as needed to support the semantics of simulation. During elaboration, the parts of the module hierarchy (modules, ports, primitive channels, and processes) are created, and ports are bound to channels. The illusion of concurrency is provided to the user by a simulation kernel implementing a discrete event scheduler. Simulation involves the execution of the scheduler, which in turn may execute processes within the application.

SystemC Scheduler: The primary purpose of the scheduler is to trigger or resume the execution of the processes that are part of the application. The functionality of the scheduler (as specified in the IEEE 1666 Language Reference Manual for SystemC) can be summarized as follows:

1. Initialization Phase: Initialize every eligible method and thread process instance in the object hierarchy to the set of runnable processes.

2. Evaluation Phase: From the set of runnable processes, select a process instance in an unspecified order and execute it non-preemptively. This can, in turn, notify other events, which can result in new processes being ready to run. Continue this step until there are processes ready to run.

3. Update Phase: Update signal values for all processes in step 2 that requested the update.

4. δ-Notification Phase: Trigger all pending δ-delayed notifications, which can wake up new processes. If, at the end of this phase, the set of runnable processes is non-empty, go back to the evaluation phase.

5. Timed-Notification Phase (T): If there are pending timed notifications, advance simulation time to the earliest deadline. Determine the set of runnable processes that can run at this time and go to step 2. Otherwise, end simulation.

To simulate synchronous concurrent reactions on a sequential computer SystemC supports the concept of a δ-cycle. A delta (δ)-cycle is an event cycle (including the evaluate, update and δ-notification phase) that occurs in 0 simulation time.

Nondeterminism: For a given input, a program is nondeterministic if it produces different output behavior. An election algorithm of the SystemC scheduler makes the output of a program deterministic. As such, simulation of a SystemC program cannot guarantee correctness due to its inability to produce all possible behavior. To illustrate this let us consider the processes P₁ and C₁ from the example in FIG. 2 with MAX=2 and x=4. The program has the following 4 possible executions where r denotes a time elapse:
P₁C₁τP₁C₁τP₁C₁ and P₁C₁τP₁C₁τC₁P₁ leads to a successful termination of the program with 2 A's being produced and consumed.
P₁C₁τC₁P₁ leads to a deadlock situation. The process C₁ is waiting for the event e (line 24) and the process P₁ has terminated.
C₁(P₁τ)* leads to an array bound violation as process C₁ waits for the event e and process P₁ goes on producing in the array data.

With the reference OSCI simulation kernel, only the first execution will be scheduled and the other buggy executions will be ignored. Thus, it is important to test all possible execution of a SystemC design. Now consider the same example with all 3 processes and MAX=8 and x=2. It has 3701 possible executions. A naive algorithm will try to explore all possible executions one by one and will face scalability issues. A technique which for most practical cases copes with this scalability problem is called partial order reduction (POR). In the present principles, only 767 executions are explored of all possible executions and the problem still remains provably sufficient for detecting deadlocks and assertion violation.

FORMAL SETTING: A state of a SystemC program includes the local state (LocalState) of each process in the program, and of the shared state (SharedState) of all communication objects:

State=SharedState×LocalStates

LocalStates=P→LocalState

For ls∈ Local States, we denote ls[p:=l] the map that is identical to ls except that it maps p to local state l. What follows are standard definitions used in the context of Partial Order Reduction, which has been adapted here for SystemC.

Transition: A transition moves the system from one state to a subsequent state. In SystemC there are three types of transition:

1. Immediate-transition: change the state by executing a finite sequence of operations of a chosen process followed by a wait operation or termination of the same process.

2. δ-transition takes the system from one state to the next by updating all the signals, and by triggering all the δ-delayed notification that were requested in the current delta cycle.

3. A time-transition: change the system state by updating the simulation time.

The transition t_{p,l} of process p for local state l∈ Local State is defined via a partial function:

t_{p,l}: SharedState→SharedState×LocalState
Let T denote the set of all transitions of the system. For t_{p,l}∈T, we denote Process(t_{p,l}) as the process p.

Runnable: A transition t_{p,l}∈T is runnable in a state s=<g,ls> (where g∈ SharedState and ls∈ Localstates), written t∈ runnable(s) if l=ls(p) and t_{p,l}(g) is defined.

If t∈ runnable(s) and t_{p,t}(g)=<g′,ls′>, then we say the execution of t from s produces a successor state s′=<g′,ls[p:=l′]>, written

$$s {}^{t} {s}^{′} .$$

We write

$$s {⇒}^{w} {s}^{′}$$

to mean that the execution of the finite sequence w∈T* leads from s to s′. A state s, where runnable(s)=0 is called a deadlock, or a terminating state.

The behavior of a SystemC program is represented using a transition system M=(State, s₀,Δ), where State: Exp is a finite non-empty set of states, so is the initial state of the system and Δ⊂ State×State is the transition relation defined by relation defined by

$$( s , {s}^{′} ) ∈ Δ iff ∃ t ∈ T : s {->}^{t} {s}^{′} .$$

A transition t₁∈T is called co-runnable with another transition t₂∈T, written CoRunnable(t₁, t₂) if is ∃s∈State such that both t₁, t₂ runnable(s). Note that 2 transitions of the same process cannot be co-runnable in SystemC. An execution of the program is defined by a trace of the system.

Trace: A trace φ∈T* of M is a finite (possibly empty) sequence of transitions t₀, . . . , tₙ₋₁ where there exists states s₀, . . . ,sₙ such that s₀ is the initial state of M and

$${s}_{0} {->}^{{t}_{n}} {s}_{1} … {->}^{{t}_{n - 1}} {s}_{n} .$$

A trace can be denoted by φ, π, ψ. For a given trace:
φᵢ represents the transition t₁.
φ_{0 . . . 1} denotes the trace t₀, . . . ,t₁
Pre(φ,i)=s₁ and Post(φ,i)=sᵢ₊₁.
   Our goal is to explore all possible traces of the system M. However, N typically includes many traces that are simply different in execution order of uninteracting transitions that leads to a same final state. This observation has been exploited by partial order reduction techniques to explore a subset of the possible traces, while still being provably sufficient for detecting deadlocks and assertion violation. The following definition states the condition when two transitions are independent, meaning that they result in the same state when executed in different orders.

Independence Relation: A relation I [symbol] T×T is an independence relation of M if I is symmetric and irreflexive and the following conditions hold for each s∈ State and for each (t₁,t₂)∈I:

1. if t₁,t₂∈ runnable (s) and

$$s {->}^{{t}_{1}} {s}^{t}$$

then t₂∈ E runnable(s′)

2. if t₁,t₂∈ runnable(s), then there is a unique state s′

$$such that s {⇒}^{{t}_{1} {t}_{2}} {s}^{′} and s {⇒}^{{t}_{2} {t}_{1}} {s}^{′}$$

Transitions t₁t₂∈T are independent in M if (t₁,t₂)∈I. Thus, a pair of independent transitions cannot make each other runnable when executed and runnable independent transitions commute. The complementary dependence relation is given by (T×T)−I. Two traces are said to be equivalent if they can be obtained from each other by successively permuting adjacent independent transitions. Thus, given a valid independence relation, traces can be grouped together into equivalence classes. For a given trace, we define a happens-before relation between its transitions as follows.

Happens-before: Let φ=t₀ . . . tₙ be a trace in M. A happens-before relation [symbol] is the smallest relation on {0 . . . n} such that

1. if i<j and φᵢ is dependent on φⱼ then i [symbol] j.
2. [symbol] is transitively closed.

This happens-before relation is a partial order relation also known as Mazurkiewicz's traces. The correspondence between equivalence classes of traces and the partial order relation [symbol] is that the equivalence class containing the trace φ is the set of all linearizations of the partial order. In the present embodiments, we use a variant of the above happens-before relation which is defined as follows: for a given trace φ=t₀ . . . tₙ in M and i∈{0 . . . n}, i happens-before process p, written, i [symbol] p if either

1. Process (φᵢ)=p, or

2. ∃k∈{i+1, . . . ,n} such that i [symbol] k and Process(φₖ)=p.

Computation of the Dependence Relation: One goal is to execute only one trace from each equivalence class for a given dependence relation. Thus, the first step is to compute these dependence relations. We use static analysis techniques to compute if two transitions are dependent. Two transitions t₁,t₂∈T are dependent (t₁, t₂)∈D if they operate on some shared communication objects. In particular, we use the following rules to compute the dependence relation D, i.e., ∀t₁,t₂∈T,(t₁,t₂)∈D if any of the following holds:

1. a write on a shared non-signal variable ν in t₁ and a read or a write on the same variable ν in t₂.

2. a write on a shared signal variable s in t₁ and a write on the same variable s in t₂.

3. a wait on an event e in t₁ and an immediate notification on the same event e in t₂.

Note here that the order in which the statements occur within a transition does not matter. For each transition t∈T, we maintain four sets—read and write sets for shared non-signal variables and shared signal variables (written, R_{t1,ns}, w_{t,ns}, R_{t,s}, W_{t,s} respectively). Thus, rule 1 can be re-written as,

(Wₜ_{₁},ns∩Rₜ_{_{2,}},ns)∪(T₁,ns∩Wₜ_{_{2,ns}})≠0

and rule 2 can be re-written as,

Wₗ_{_{]}}_{,s}∩Wₜ_{₂}_{,s}≠0.

In the rules mentioned above, in general, two transitions with write operations on a shared variable are dependent. But, to exercise more independency, we consider special cases of write operations (called symmetric write) that can be considered as being independent: for example, two constant addition or constant multiplication with the same variable can be considered as being independent. We also use static slicing techniques to remove irrelevant operations to further extract more independency between the transitions. If a statement does not influence the property that we are checking than that statement can be removed in the sliced program.

To illustrate the above rules, consider the example from FIG. 4. Consider the transition of lines (6-9) in process P₁ and the transition of lines (11-18) in process P₂. In general, these two transitions are dependent because they both write to the variable data and num. However, if the property that we are checking is the assertion in line 12 then we can get a sliced program by removing the statements inside the box, while still remaining correct for detecting the assertion violation. Now, if we consider only the rules 1, 2 and 3 from above then the two transitions are still dependent in the sliced program because they both write to the variable num. Notice that both the writes to the variable num are symmetric (increment). Thus, we have that the two transitions are independent if the property that we are checking is only the assertion (num<2) at line 12.

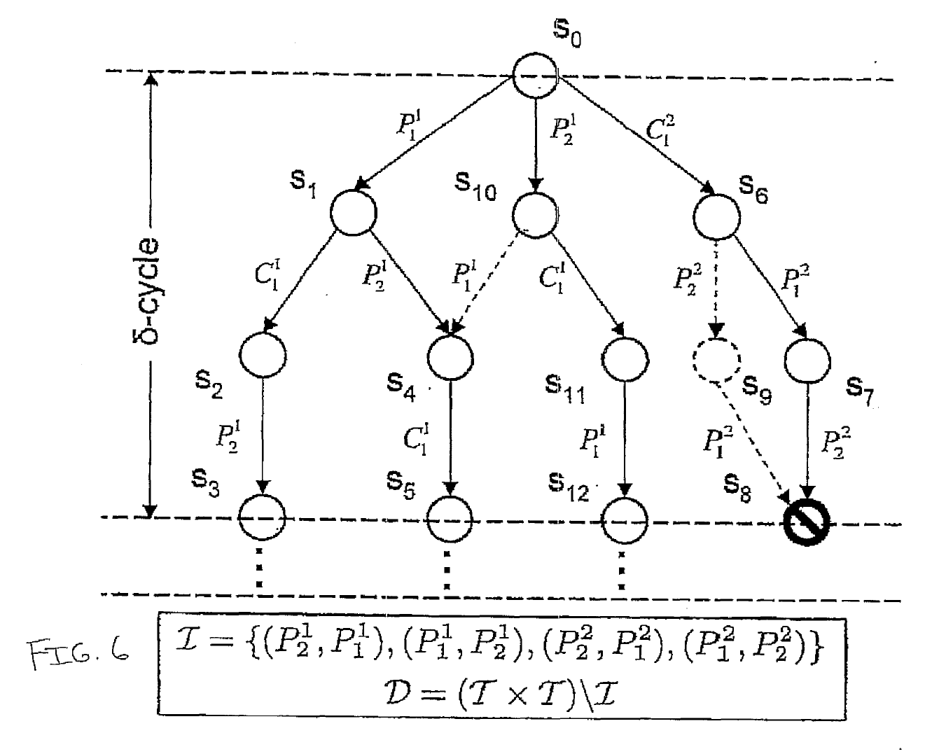

The Explore Algorithm: The Explore algorithm shown in lines 6-20 of FIG. 5, explores a reduced set of possible executions of the SystemC design. The method in accordance with the present principles is stateless, i.e., it stores no state representations in memory but only information about which transitions and traces that have been executed so far. Although, the present approach does not need to maintain state information, and needs considerably less memory, especially when the design has a large number of variables. The present approach explores each nonequivalent trace of the system by re-executing the design from its initial state.

FIG. 5 maintains a sched of type Schedule. A Schedule is a sequence of SchedulerState. Each SchedulerStates is a 3-tuple (Runnable, Todo, Sleep) where, Runnable is a sequence of Transition that are runnable in state a, Todo is a set of Transition that needs to be explored from a, and Sleep is the set of Transition that are no longer needed to be explored from s. The method of FIG. 5 also uses a function Simulate (not shown) that takes as input a prefix schedule and then executes it according to the trace corresponding to the schedule. Once the prefix trace ends, it randomly chooses a runnable transition that is not in the Sleep Set of the current state and executes it. The function continues the above step until completion of the simulation and returns the Schedule for the current execution. To further reduce the explored transitions, the Simulate function maintains a sleep set for each state in the same way as explained above.

The Explore function starts by executing a random schedule (as the prefix trace is φ) and returns the schedule in sched (line 7). The method of FIG. 5 traverses the execution-tree bottom up and index maintains the position in the tree such that the sub-tree below index has been fully explored. Note that by traversing the execution-tree bottom-up, we need to maintain very little state information. While we have not traversed the entire execution-tree, let sched=s₀, . . . s_{index}, . . . sₙ then φ=t₀, . . . tᵢ, . . . tₙ₋₁ is the trace corresponding to sched such that tᵢ=sᵢ. Runnable.At(0) and s=s_{index}. Using the computed trace φ, the Explore method then finds out the transitions that can-be-dependent with the transition φ_{index} using the function Analyze (line 12) and adds those in the Todo set of the corresponding state. Then, if there exists any transition t∈ Todo\Sleep in the state s (line 13), then the Explore function swaps the transition t with the first element of Runnable in state a (line 14), copies the prefix schedule (line 15) and simulates it using the Simulate function (line 16). Otherwise, we have explored all required transitions in the sub tree below index and now will explore all the transitions in the sub tree below index−1 (line 19). Note that in contrast to some other concurrent languages, in SystemC, a runnable process cannot be disabled by other processes.

We obtain partial order of runnable processes statically by identifying the dependent transitions. Note here that a transition in SystemC is an atomic block, which in turn is a non-preemptive sequence of operations between wait to wait. Note, due to branching within an atomic block, such blocks may not be derived statically. An atomic execution is dependent on another atomic execution if it is enabled or disabled by the other or there exists read-write conflicts on the shared variable accesses in these blocks.

We first derive a wait-notify control skeleton of the SystemC design, and then enumerate all possible atomic blocks, we then perform dependency analysis on the set of atomic blocks, and represent the information symbolically. Similarly, we obtain read-write synchronization constraints between the atomic blocks, and represent them symbolically. In the procedure, Analyze (line 24), we query to check if a given pair of atomic blocks (corresponding to the runnable processes) need to be interleaved. If not, we do not consider that interleaving of runnable processes. Optionally, we can use dynamic information to do the query. However, using static information, we gain in performance.

The Analyze function takes as an argument a trace φ and an integer index. Next, the Analyze function gets the start of the delta cycle to which φ_{index} belongs (line 22). Then, for each transition (φᵢ such that i<index and belongs to the same delta cycle (line 23)), we check if φᵢ and φ_{index} are dependent (line 24) and may be co-runnable (line 25). If true, then we compute the state s-Pre(φ,i) and p as the process to which the transition φ_{index} Pint belongs. Next, if there exists a transition of p that is runnable at (line 28) then it adds that transition to the Todo set of (line 29). Else, if there exists j>i such that j [symbol] p and the runnable set of s contains a transition that belongs to the process to which φⱼ belongs (line 31) then it adds that transition to the Todo set of a (line 33). Otherwise, it adds all runnable transitions to the Todo set of s (line 35).

To review the explore method, consider again the example from FIG. 4 with all 3 processes and MAX=1 and x=2. A partial execution-tree for this example includes only the first 5-cycles as shown in the FIG. 4.

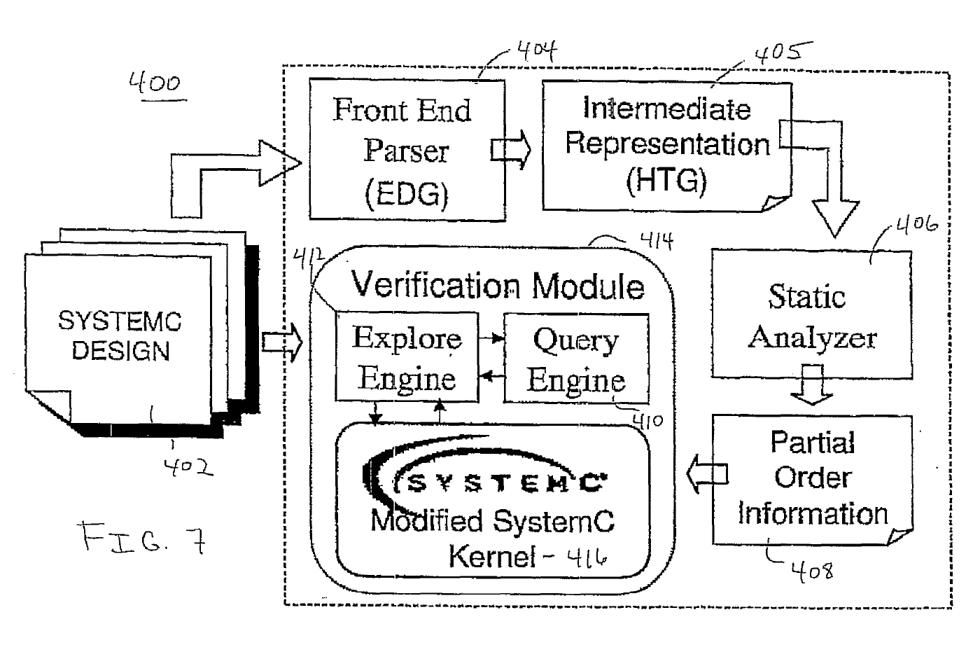

Referring to FIG. 6, suppose, that the first call to Simulate (line 7 of FIG. 5) returned the Schedule sched={s₀,s₁,s₂,s₃, . . . } after executing the corresponding trace φ={P₁¹,C₃¹,P₂¹, . . . }, where Procᵢ^{j} stands for the j^{th} transition in the process Procᵢ. The state s₀ is the initial state, and it has all three processes as runnable. The method explores the current schedule bottom up and restricts its analysis for backtracking points within a δ-cycle. When index corresponds to the state s₂, the Analyze function adds P₂¹ to the Todo set of s₁. Next, when index corresponds to the state s₁ the method adds C₁² to the Todo set of s₀ and then explores the path {P₁¹,P₂¹,C₁¹, . . . }. The method continues in this way, until the index corresponds to the state s₇. At this point, P₂¹ is added to the Todo set of s₀. The transition and state shown in dashed lines is not explored. The state s₈ is a deadlock state. Note that the transition P₁¹ is not explored in the state s₁₀ because it is in the Sleep set of s₁₀ (as P₁¹ and P₂¹ are independent). the method algorithm explores only 4 different traces out of the 8 possible traces for this example.

IMPLEMENTATION DETAILS AND PRELIMINARY RESULTS: We implemented the present method for exploring all possible valid traces of a SystemC design in a prototype framework called Satya. The implementation of Satya is very modular and includes 2 main modules—a static analyzer and a verification module. The Satya software tool is over 18,000 lines of C++ code and uses an EDG C++ front-end parser and the OSCI Systemc simulator 12]. Of those, about 17,500 are the intermediate representation (m) and utility functions needed by the static analyzer and the verification module (explore and query engine) is only about SOD lines.

Referring to FIG. 7, an overview of a framework 400 (e.g., the Satya framework) is illustratively shown in accordance with one illustrative embodiment. An SLD (e.g. SystemC design) is taken as input in block 402. The design may have the restriction of no dynamic casting and no dynamic process creation. After parsing the design description using a front-end parser 404, we capture the EDG intermediate language (IL) into our own intermediate representation (IR) 405 that includes basic blocks encapsulated in Hierarchical Task Graphs (HTGs), for example. We choose HTC over other IRs like CDFG, as it maintains the hierarchical structuring of the design such as if-then-else blocks and for- and while-loops which are used during static analysis. A static analyzer 406 works on the HTGs in a compositional manner to generate dependency relations (partial order information in block 408), which are then used by a query engine 410. An implementation of an explore engine 412 follows closely the method described in FIG. 5. The SystemC design 402 is compiled with a verification module 414 which includes a modified OSCI SystemC kernel 416. The modified kernel 416 takes as input a prefix schedule that acts as a golden reference for the current run and returns the schedule for the current run after executing it until completion. The modifications are still in compliance with the SystemC specification.

We provide a scalable approach for testing SystemC in a query-based framework, Satya. The present approach combines static and dynamic POR techniques to reduce the number of interleavings needed to expose all behaviors of SystemC. The approach exploits SystemC specific semantics to reduce the number of backtracking points.

Having described preferred embodiments of a system and method for partial order reduction for scalable testing in system level design (which are intended to be illustrative and not limiting), it is noted that modifications and variations can be made by persons skilled in the art in light of the above teachings. It is therefore to be understood that changes may be made in the particular embodiments disclosed which are within the scope and spirit of the invention as outlined by the appended claims. Having thus described aspects of the invention, with the details and particularity required by the patent laws, what is claimed and desired protected by Letters Patent is set forth in the appended claims.

What is claimed is:

1. A method for concurrent program testing, comprising:
determining dependency relations of running processes in a concurrent program and organizing them in a matrix;
obtaining a reduced set of possible interleavings of processes by removing equivalent interleavings as determined with respect to the dependency relations; and
exploring the reduced set of interleavings to verify operation of the program.

2. The method as recited in claim 1, wherein determining dependency relations includes:
enumerating atomic blocks including sequences of transitions;
obtaining shared variables in each atomic block; and
identifying dependent atomic blocks that represent the dependency relations.

3. The method as recited in claim 1, wherein the dependency relations are obtained statically.

4. The method as recited in claim 1, wherein the dependency relations are obtained dynamically during exploration.

5. The method as in claim 1, wherein the dependency relations are maintained in a query-table, and information is obtained by querying the table during dynamic exploration.

6. The method as recited in claim 1, wherein exploring includes executing an interleaving from the reduced set, and analyzing the reachable states and transitions.

7. The method of claim 6, wherein exploring includes stateless exploration including exploring an interleaving by re-executing the program from its initial state.

8. A computer readable medium comprising a computer readable program, wherein the computer readable program when executed on a computer causes the computer to perform the steps in accordance with claim 1.

9. A system for program testing, comprising:
a static analyzer configured to determine dependency relations of enabled running processes in a program;
a query table configured to organize the dependency relations to provide an interface for exploring the program; and
an explorer engine configured to explore a reduced set of possible interleavings in the program in a stateless exploration process that analyzes executed states and transitions to verify operation of the program.

10. The system as recited in claim 9, wherein the program includes a concurrent program for system level design (SLD) and further comprising:
a parser configured to parse an SLD to generate an intermediate representation of the SLD to be statically analyzed, and
an integration of the explorer engine with a design language specific simulation kernel.

11. The system as recited in claim 9, wherein the query table includes static and dynamic dependency information, and the query table is queried to determine whether running processes need to be interleaved.

12. The system as recited in claim 9, wherein the explorer engine explores an interleaving in the program by re-executing the program from its initial state.

13. The system as recited in claim 9, wherein dependency relations are determined by shared variables between atomic blocks including sequences of transitions and dependent atomic blocks are identified that represent the dependency relations.
